(19) United States
(12) Patent Application Publication
(10) Pub. No.: US 2021/0138741 A1
(43) Pub. Date: May 13, 2021

(54) INNOVATIVE HOLE MAKING PROCESS IN COMPOSITE LAMINATES

(71) Applicant: North Carolina Agricultural and Technical State University, Greensboro, NC (US)

(72) Inventors: Ajit D. Kelkar, Greensboro, NC (US); Vishwas S. Jadhav, Greensboro, NC (US)

(21) Appl. No.: 17/094,440

(22) Filed: Nov. 10, 2020

Related U.S. Application Data
(60) Provisional application No. 62/933,486, filed on Nov. 10, 2019.

(51) Int. Cl. B29C 70/34; B29C 70/54; B29C 70/22

(52) U.S. Cl. CPC B29C 70/34; B29K 2307/04; B29C 70/228; B29C 70/545

(57) ABSTRACT

A manufacturing method for incorporating holes in composite laminates (e.g., structural composites) is disclosed. Also described is a hole-making method for composite laminates prepared using heat vacuum assisted resin transfer molding (HVARTM) technique. In one example, the method comprises providing one or more layer of fibers; inserting one or more pins in the one or more layers of fiber; contacting the one of more layers of fiber with a resin for forming the polymeric matrix; curing the resin to form the polymeric matrix; and removing the one or more pins, thereby preparing a composite wherein the composite comprises one or more holes extending from an outer surface of the composite toward or all the way to an opposite outer surface of the composite. Composite materials produced by the method are also disclosed.

### RELATED APPLICATIONS

The presently disclosed subject matter claims the benefit of U.S. Provisional Patent Application Ser. No. 62/933,486, filed Nov. 10, 2019; the disclosure of which is incorporated herein by reference in its entirety.

### TECHNICAL FIELD

The presently disclosed subject matter relates to a manufacturing method for incorporating holes in composite laminates.

### BACKGROUND

The ability to optimally tailor composite materials is one of the benefits of composites. High specific strength, stiffness and low coefficient of thermal expansion are some of the most desirable properties for composites, including those materials used in structural applications. Composites, including but not limited to carbon- and glass fiber-reinforced polymers, have found increasingly wide applications not only in aerospace, transportation, defense, and sporting goods, but are also increasing market share in civil infrastructure applications due to their unique advantages over traditional metal and concrete materials.

One advantage of composite structures is that instead of several component parts, composites are manufactured as a single structure, such as a monocoque, thereby optimizing cost and minimizing the number of joints. Larger composite structures may require fabrication of several substructures, which are then assembled into a single large structure, for example airframe structures consist of assembly of wings, fuselage, skin, frames, spars etc. Joining these composite substructures allows the creation of lightweight structures with complex shapes. Joining substructures is typically performed using two primary methods: mechanical fastening and adhesive bonding, but there are drawbacks to each.

Adhesive bonding provides an efficient load transfer, excellent fatigue properties, small stress concentration, stiff connections and relatively lightweight products, but adhesively bonded joints are not always practical. Adhesive bonding may also require overly thick components to be joined with simple joint configuration and residual stress may occur, leading to unintended problems. Adhesively bound components cannot be easily disassembled once cured, requiring costly tooling and expansive, and expensive, repair facilities. Non-destructive inspection procedures are generally unable to detect weak or potentially weak adhesive bonds and a high level of quality control is needed to obtain and maintain reliable and robust bonding.

Mechanical fastening is a lower cost option, as it requires low cost tooling and inspection, and is a more straightforward and more reliable joining process. Bolted joints are easily disassembled, have no thickness limitations, employ a simple manufacturing process and result in a low initial risk. For mechanical fastening of substructures, holes are necessary to accommodate hardware such as fasteners, which are typically incorporated by cutting through the fibers of the composites. Such holes are generally drilled using a twist drill, a process which is fast and economical. Non-traditional machining processes, such as water-jet machining, ultrasonic machining, electrical discharge machining, etc. are alternative methods for machining holes. Due to the nonhomogeneous and anisotropic property of fiber-reinforced panels, drilling such composite materials is different than machining conventional metals and their alloys. Drilling composites materials can lead to damage including, but not limited to, splintering of fibers, delamination, burrs, microcracks, matrix burning around the hole, fiber peel-up at entry, and push out at exit. As a result of such damage, composite structures may fail prematurely, thereby reducing the lifespan of the product.

Thus, there remains a need for an effective method for incorporating holes in composite materials, including structural composites, that does not lead to weakening of the composite itself.

### SUMMARY

In some embodiments, the presently disclosed subject matter provides a method of preparing a composite comprising a polymeric matrix and one or more layer of fabric, wherein the composite contains one or more holes. In some embodiments, the method comprises (a) providing one or more layer of fibers; (b) inserting one or more pins in the one or more layers of fibers; (c) contacting the one of more layers of fibers with a resin for forming the polymeric matrix; (d) curing the resin to form the polymeric matrix; and (e) removing the one or more pins, thereby preparing a composite wherein the composite comprises one or more holes extending from an outer surface of the composite toward or all the way to an opposite outer surface of the composite. In some embodiments, the composite is a structural composite.

In some embodiments, the presently disclosed subject matter provides a composite prepared by a method of the presently disclosed subject matter.

In some embodiments, the presently disclosed subject matter provides a composite material comprising a polymeric matrix; and one or more layers of fibers surrounded by the polymeric matrix; wherein the composite material comprises one or more holes extending from one outer surface of the composite material toward or through an opposite outer surface of the composite material or wherein said one or more holes extends through at least one of the one or more layers of fibers. In some embodiments, the one or more layers of fibers are free of broken and/or pulled fibers at or near the vicinity of the one or more holes and/or the composite material is free of delamination and/or cracks emanating from the one or more holes.

In some embodiments, the one or more layers of fibers comprise carbon fibers, glass fibers, metallic fibers, or ceramic fibers. The fibers commonly comprise carbon fibers or glass fibers. In some embodiments, the one or more layers of carbon fibers or glass fibers comprise plain weave, twill, satin, or 8 harness weave. Generally, the composite comprises only a single fiber weave, that is only plain weave, only twill, only satin or only 8 harness weave. The selection of a particular weave is based on the shape needed for the composite.

In some embodiments, the one or more layers of fiber comprises at least about 4 layers of fiber. According to the methods disclosed herein, there is no upper limit on the number of fiber layers that can be used. However, typically 128 layers yield a 2 inch thick composite, and so composites of more than 128 layers are not common, unless thickness is not an issue and the corresponding strength is needed for the composite, for example, a structural composite to be used as part of a tank.

In some embodiments, step (c) of the method comprises contacting the one or more layers of fiber with a resin for forming a thermoset polymeric matrix and a curing agent. In some embodiments, the resin for forming a thermoset polymeric matrix is an epoxy resin. In some embodiments, the curing of step (d) is performed using heat. In some embodiments, the contacting of step (c) and the curing of step (d) are performed using a mold; alternately, each of step (c) and step (d) are performed in the absence of a mold. In some embodiments, the contacting and curing steps are performed as part of a vacuum assisted resin transfer molding (VARTM) or heated vacuum assisted resin transfer molding (HVARTM) process.

In some embodiments, one or more of a compressive strength, a tensile strength, or a fatigue life of the composite of the presently disclosed subject matter is greater than a compressive strength, a tensile strength, or a fatigue life of a composite comprising drilled or waterjet cut holes and/or the composite is free of cracks propagating from a side of a hole into the polymeric matrix. In some embodiments, the compressive strength of the composite of the presently disclosed subject matter is at least about 38% more than the compressive strength of a composite comprising traditionally prepared holes, such as drilled or water jet cut holes. In other embodiments, the tensile strength of the composite of the presently disclosed subject matter is at least about 28% more than the tensile strength of a composite comprising traditionally prepared holes, such as drilled or water jet cut holes. In still other embodiments. the fatigue life of the composite of the presently disclosed subject matter is at least about 400% more than the fatigue life of a composite comprising traditionally prepared holes, such as drilled or water jet cut holes. In some embodiments, the composite of the presently disclosed subject matter can sustain more compressive or tensile stress than a composite comprising traditionally prepared holes, such as drilled or waterjet cut holes.

In some embodiments, the method further comprises joining the composite, optionally a structural composite, to another structure. In some embodiments, the joining comprises mechanical fastening. Such mechanical fastening can occur via one or more of the holes prepared according to the methods disclosed herein.

In some embodiments, the composite of the presently disclosed subject matter is used as a part for a vehicle, a piece of sporting equipment, a component part of a building, or a part of a civil infrastructure installation.

Accordingly, it is an object of the presently disclosed subject matter to provide a manufacturing method for incorporating holes in composites. In some embodiments, the composites are woven composite laminates.

An object of the presently disclosed subject matter having been stated hereinabove, and which is achieved in whole or in part by the presently disclosed subject matter, other objects will become evident as the description proceeds when taken in connection with the accompanying drawings as best described herein.

### BRIEF DESCRIPTION OF THE DRAWINGS

FIG. 1 is a schematic for the fabrication of a composite panel using a heated vacuum assisted resin transfer molding (HVARTM) process.

FIG. 2 is an image of two pins inserted in fiber plies before application of a resin in accordance with a representative embodiment of a method of the presently disclosed subject matter.

FIG. 3 is a graph of the curing cycle for composite laminates.

FIG. 4 includes images of coupons containing a hole created by a drilling machine, including a burr inside the hole.

FIG. 5A is an image of the failure pattern after the Open Hole Compression Test (ASTM D6484) for a drilled hole sample.

FIG. 5B is an image of the failure pattern after the Open Hole Compression Test (ASTM D6484) for a waterjet cut hole.

FIG. 5C is an image of the failure pattern after the Open Hole Compression Test (ASTM D6484) for a hole made by the method of the presently disclosed subject matter.

FIG. 6 is a graph of load (kN) vs extension (mm) of sample composites having holes created with different drilling methods (drilled, waterjet cut, and the method of the presently disclosed subject matter, “pin inserted”).

FIG. 7A is an image of the failure pattern after the Tensile Strength Test for composites having holes made by the method of the presently disclosed subject matter.

FIG. 7B is an image of the failure pattern after the Tensile Strength Test for composites having holes made by a waterjet cut.

FIG. 7C is an image of the failure pattern after the Tensile Strength Test for composites having holes made by drilling.

FIG. 8A includes images of the failure pattern after the fatigue test (80% loading) for two pin inserted samples.

FIG. 8B is an image of the failure pattern after the fatigue test (80% loading) for a drilled hole sample.

FIG. 8C is an image of the failure pattern after the fatigue test (80% loading) for a water-jet cut hole sample.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. For example, features illustrated with respect to one embodiment can be incorporated into other embodiments, and features illustrated with respect to a particular embodiment can be deleted from that embodiment. Thus, one or more of the method steps included in a particular method described herein can, in other embodiments, be omitted and/or performed independently. In addition, numerous variations and additions to the embodiments suggested herein, which do not depart from the instant invention, will be apparent to those skilled in the art in light of the instant disclosure. Hence, the following description is intended to illustrate some particular embodiments of the invention, and not to exhaustively specify all permutations, combinations and variations thereof. It should therefore be appreciated that the present invention is not limited to the particular embodiments set forth herein. Rather, these particular embodiments are provided so that this disclosure will more clearly convey the full scope of the invention to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. DEFINITIONS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. References to techniques employed herein are intended to refer to the techniques as commonly understood in the art, including variations on those techniques or substitutions of equivalent techniques that would be apparent to one of skill in the art.

Following long-standing patent law convention, the terms “a”, “an”, and “the” refer to “one or more” when used herein, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.”

As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed subject matter can include the use of either of the other two terms.

Unless otherwise indicated, all numbers expressing quantities of weight, mass, volume, time, activity, percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

As used herein, “composite” or “composite material” refers to a combination of two or more materials. The materials generally possess different physical or chemical properties that remain separate and distinct on a macroscopic level within the finished product. For example, a fabric (or fiber) may be considered one material and a resin another material. The fiber reinforcements of the fabric or fiber in a composite can provide mechanical properties such as stiffness, tension and impact strength. The resin material can provide physical characteristics such as resistance to fire, weather, ultraviolet light and chemicals.

As used herein, “structural composite” refers to a composite material used for carrying a load.

As used herein, a “fiber” is a long strand of a material, such as a strand comprising a carbon, glass, ceramic, or metal material, the length dimension of which is much greater than the transverse dimensions of width and thickness. The fiber is preferably a long, continuous strand rather than a short segment of a strand referred to in the art as a staple fiber. A strand is a single, thin length of something, such as a thread or fiber. The cross-sections of fibers for use herein may vary widely, and they may be circular, flat or oblong in cross-section. They also may be of irregular or regular cross-section. Thus, the term “fiber” includes filaments, ribbons, strips and the like having regular or irregular cross-section.

A fiber layer may comprise any type of uni-axial or multi-axial fabric, including a single-ply of unidirectionally oriented or randomly oriented (i.e. felted) non-woven fibers, a plurality of plies of non-woven fibers that have been consolidated into a single unitary structure, a single-ply of woven fabric, a plurality of woven fabric plies that have been consolidated into a single structure, a single-ply of knitted fabric or a plurality of knitted fabric plies that have been consolidated into a single structure. In this regard, a “layer” describes a generally planar arrangement having an outer top (first) planar surface and an outer bottom (second) planar surface.

The “fabric” or “fiber” in a composite can be woven or non/woven. Fibers can be ceramic, metal, glass or carbon. Glass fibers and carbon fibers are the most commonly used materials.

### II. GENERAL CONSIDERATIONS

The use of composites is growing in part because composites reduce overall weight without losing strength or stiffness. In particular, the use of structural composites for aerospace, defense, automotive and marine applications has increased dramatically. Larger composite structures typically require fabrication of several substructures, which are then assembled into a single large structure; examples include airframe structures such as wings, fuselage, skin, frames, spars, etc. The joining of individual composite parts enables the manufacture of lightweight structures with complex shapes and is typically performed using mechanical fastening and/or adhesive bonding. Mechanical fastening requires cutting holes through the composite fibers and those holes disturb the load path within the composite. Adhesive bonding creates no such holes but is not always practical for the intended composite use.

“Fatigue” generally refers to the weakening or failure of a material. Fatigue is generally due to cyclic loads, where the load oscillates between a maximum and minimum, in contrast to a constant load. “Fatigue failure” typically comprises three stages: crack initiation, crack propagation, and fracture. Fatigue failure usually begins with a small crack, which may be minute and not easily detected; such cracks usually initiate at a point of localized stress concentration, for example a change in a cross section, a keyway, or a hole. After crack initiation, the stress concentration increases leading to rapid crack propagation and ultimately fracture, which results in component failure.

An important design criterion for structures in aerospace applications is withstanding fatigue loading, since most structures are subject to cyclic loads over their lifetime. Most aircraft structures, such as the fuselage, undergo tension-tension fatigue. Structural components of aircraft fuselage are joined using mechanical fastening, bolted or pinned joined, resulting in holes in the fuselage skin. Typically, holes are drilled using a twist drill, a process which is fast and economical. Non-traditional machining processes, including but not limited to water-jet machining, ultrasonic machining, and electrical discharge machining, are alternative methods known to those of ordinary skill in the art for machining holes. Due to the nonhomogeneous and anisotropic property of fiber-reinforced panels, drilling of composite materials differs from machining of conventional metals and their alloys. Drilling causes damage including, but not limited to, splintering of fibers, delamination, burrs, microcracks, matrix burning around the hole, fiber peel-up at entry, and push out at exit. Due to such damage, composite structures can fail prematurely, reducing the structure's life span.

In some embodiments, the presently disclosed subject matter provides a method of manufacturing holes in a composite laminate by inserting a pin, such as a metal pin, during the manufacturing process. A significant reduction in stress concentration is exhibited around holes prepared in accordance with a method of the presently disclosed subject matter. The composites comprising holes manufactured according to the present methods, when used in mechanically joined, such as bolted composite structures, exhibit better performance under both static and fatigue loading compared to bolted composite structures manufactured using holes drilled by conventional methods.

### III. METHODS OF MANUFACTURE

In some embodiments, the presently disclosed subject matter provides a hole making manufacturing method for composite laminates, including structural composites. In some embodiments, the laminates are fabricated using a heated vacuum assisted resin transfer molding (HVARTM) technique (shown schematically in FIG. 1). Consistent with the method disclosed in U.S. Pat. No. 9,114,576 and in Bolick, R. L., Kelkar, A. D. Innovative Composite Processing by Using H-VARTM method SAMPE Europe, Paris Apr. 2-4, 2007 in the HVARTM set up, the mold, 100, is laid on a heating pad, 150. The layers of fibers, 200, are held between release fabric 300 and 350; the top release fabric is covered with the distribution medium 400, such as a plastics mesh and the vacuum bag, 500, such as a nylon film, covers the components as shown. A vacuum pump, 600 and a resin suction, 700, facilitate the flow of resin through the fibers. In some examples, the composites comprise plain weave carbon fibers and epoxy resin. Plain weave carbon laminae are stacked together and metal pins are inserted in dry laminae at particular distances without causing any damage to the carbon fiber strands. Such pins can be inserted stepwise—for example, a conical can be used to push aside fibers substantially without breaking them, then a non-conical pin, such as a metal pin, can be inserted into the hole created by the conical pin. In some examples, the stacked plies are then infused with a resin, such as an epoxy resin, to fabricate laminates. The laminates are cured and after curing, the metal pins are popped out from the laminate, yielding holes in the panels without any substantial damage to the continuous carbon fiber strands.

In some embodiments, the presently disclosed subject matter provides a method of preparing a composite comprising a polymeric matrix and one or more layer of fiber. In some embodiments, the method comprises providing one or more layer of fiber; inserting one or more pins in the one or more layers of fiber; contacting the one of more layers of fiberwith a resin for forming the polymeric matrix; curing the resin to form the polymeric matrix; and removing the one or more pins, thereby preparing a composite wherein the composite comprises one or more holes extending from an outer surface of the composite toward or all the way to an opposite outer surface of the composite. In some embodiments, the hole in the composite goes from an surface through to the opposite outer surface of the composite. In some variations of any of the disclosed embodiments, the composite is a structural composite.

In some embodiments, the one or more layers of fibers comprise carbon fibers, glass fibers, metallic fibers, or ceramic fibers. The fibers commonly comprise carbon fibers or glass fibers. In some embodiments, the one or more layers of fibers comprise plain weave, twill weave, satin weave, or 8 harness weave. Generally, the composite comprises only a single fiber weave, that is only plain weave, only twill weave, only satin weave or only 8 harness weave. The particular selection of weave is based on the shape needed for the composite.

In some embodiments, the one or more layers of fiber comprises at least about 4 layers of fiber. According to the methods disclosed herein, there is no upper limit on the number of fiber layers that can be used. However, typically 128 layers yield a 2 inch thick composite, and so composites of more than 128 layers are not common, unless thickness is not an limiting factor and the corresponding strength is needed for the composite, for example, in a structural composite used to make a tank.

The pins can comprise any suitable material, but typically comprise a metal. For example, the pins can be made of steel. The pins can be inserted in the one or more fiber layers in any desired location or configuration, such as but not limited to a configuration based on an intended end use or application for the composite material. The pins can have any suitable cross-sectional shape (e.g., round, square, triangular, hexagonal, etc.) or diameter. The pins can be treated with a release agent, such as prior to insertion, to facilitate removal from the one or more fabric layers, after curing or after composite formation, for example. As described in the Examples presented herein below, a representative release agent is commerically available under the trade name FREKOTE™770-NC (Henkel IP & Holding GMBH, Duesseldorf, Germany). However, any suitable release agent as would be apparent to one of ordinary skill in the art upon a review of the instant disclosure can be employed.

In some embodiments, contacting the one of more layers of fibers with a resin for forming the polymeric matrix comprises contacting the one or more layers of fiber with a resin for forming a thermoset polymeric matrix and a curing agent. In some embodiments, the resin for forming a thermoset polymeric matrix is an epoxy resin. In some embodiments, curing the resin to form the polymeric matrix is performed using heat. In some embodiments, the contacting and curing steps are performed using a mold; alternately each of contacting and curing are performed in the absence of a mold. In some embodiments, the contacting and curing steps are performed as part of a vacuum assisted resin transfer molding (VARTM) or heated vacuum assisted resin transfer molding (HVARTM) process.

In some embodiments, one or more of a compressive strength, a tensile strength, or a fatigue life of the composite of the presently disclosed subject matter is greater than a compressive strength, a tensile strength, or a fatigue life of a composite comprising holes traditionally prepared, including drilled or waterjet cut holes. In some embodiments, the composite is free of cracks propagating from a side of a hole into the polymeric matrix. In some embodiments, the compressive strength of the composite is at least about 38% more than the compressive strength of a composite comprising traditionally prepared holes, such as drilled or water jet cut holes. In other embodiments, the tensile strength of the composite is at least about 28% more than the tensile strength of a composite comprising traditionally prepared holes, such as drilled or water jet cut holes. In still other embodiments. the fatigue life of the composite is at least about 400% more than the fatigue life of a composite comprising drilled or water jet cut holes. In some embodiments, the composite can sustain more compressive or tensile stress than a composite comprising traditionally prepared holes, such as drilled or waterjet cut holes. Representative, non-limiting techniques for assess characteristics of the composite are disclosed in the Examples presented herein below.

As described in the Examples set forth herein below, the effects of a variety of methods of including holes on composite were determined. In particular, the compressive strength of plain weave carbon fiber reinforced epoxy composites containing holes was investigated. Holes were manufactured by drilling, waterjet cutting and a method of the presently disclosed subject matter, comprising inserting a pin in the fiber before preparation of the composite. The method of the presently disclosed subject matter yielded a composite having a hole wherein the composite had a 40% increase in compressive strength compared to a composite having a hole made by traditional methods. The percentage compressive strain increased by about 50% as compared to making a hole by traditional drilling machining; there was a rise of about 25% compressive strain compared to the nontraditional waterjet machining. The strain energy absorbed during the compressive strength test was much higher for holes fabricated by the method of the presently disclosed subject matter, using a pin, compared to holes fabricated using either traditional drilling and nontraditional water jet machining.

In some embodiments, the method further comprises joining the composite to another structure via the prepared holes. In some embodiments, the method comprises joining the composite to another composite part via mechanical fastening. In some embodiments, the composite is used as a part for a vehicle (e.g., a car, truck, tank, airplane, boat, or spacecraft), a piece of sporting equipment, a part of a building, or a part of a civil infrastructure installation.

### IV. COMPOSITE MATERIALS

In some embodiments, the presently disclosed subject matter provides a a composite (e.g., a structural composite) prepared by a method of the presently disclosed subject matter.

In some embodiments, the presently disclosed subject matter provides a composite material comprising a polymeric matrix; and one or more layers of fiber surrounded by the polymeric matrix; wherein the composite material comprises one or more holes extending from one outer surface of the composite material toward or through an opposite outer surface of the composite material, wherein said one or more holes extend through at least one of the one or more layers of fiber. In some embodiments, the one or more layers of fiber are free of broken and/or pulled fibers at or near the vicinity of the one or more holes and/or the composite material is free of delamination and/or cracks emanating from the one or more holes. Representative, non-limiting techniques for assessing characteristics of the composite are disclosed in the Examples presented herein below.

In some embodiments, the one or more layers of fibers comprise carbon fibers, glass fibers, metallic fibers, or ceramic fibers. The fibers commonly comprise carbon fibers or glass fibers. In some embodiments, the one or more layers of fibers comprise plain weave, twill weave, satin weave, 4 harness weave, or 8 harness weave. Generally, the composite comprises only a single fiber weave, that is only plain weave, only twill, only satin, only 4 harness, or only 8 harness weave. The particular selection of weave is based on the shape needed for the composite and its intended use.

In some embodiments, the one or more layers of fiber comprises at least about 4 layers of fiber. According to the methods disclosed herein, there is no upper limit on the number of fiber layers that can be used. However, typically 128 layers yield a 2 inch thick structural composite, and so structural composites of more than 128 layers are not common, unless thickness is not an issue and the corresponding strength is needed for the composite.

In some embodiments, the polymeric matrix is a thermoset polymeric matrix. In some embodiments, the thermoset polymeric matrix is an epoxy matrix. In some embodiments, the one of more layers of fibers comprise carbon fibers or glass fibers. In some embodiments, the composite material is a composite material for a part for an airplane, a spaceship, a car, a truck, a boat, a building, a civil infrastructure installation or a piece of sporting equipment.

As described in the Examples set forth herein below, the effects of a variety of methods of including holes in a composite (e.g., a structural composite) were determined. In particular, the compressive strength, tensile strength and fatigue life of plain weave carbon fiber reinforced epoxy composites containing holes were investigated. Holes were manufactured by drilling, waterjet cutting and a method of the presently disclosed subject matter, comprising inserting a pin in the fiber laminae prior to addition of resin. Inserting the pin in a dry fabric to yield a hole increased compressive strength of the resulting composite by about 40%. Percentage compressive strain also increased by about 50% as compared to composites having a hole prepared by traditional drilling machining. At the same time, there was a rise of about 25% compressive strain in the composite of the presently disclosed subject matter compared to a composite prepared with a hole using nontraditional waterjet machining. The strain energy absorbed during the compressive strength test was much higher for the holes fabricated by inserting the pin compared to holes fabricated using either traditional drilling and nontraditional water jet machining.

### V. RESIN SELECTION

The selection of resin is typically dictated by the end use of the composite (e.g., the structural composite). It can be influenced by a range of factors, such as mechanical properties, environmental resistance, cost, and manufacturability. Accordingly, the properties desired in the final composite should be considered.

Representative resins and/or polymers include a “thermoset resin” and/or “thermoset polymer,” respectively. The most frequently used thermosetting resins include, but are not limited to, polyesters, epoxies, phenolics, vinyl esters, polyurethanes, silicones, polyamides, and polyamide-imides.

Suitable thermoset polymer resins include, but are not limited to, polyester, epoxy, phenolic, vinyl ester, cyanate ester, polyurethane, silicone, polyamide, and polyamide-imide resins. In some embodiments, the thermoset polymer is an epoxy resin. Epoxy resins for use according to the presently disclosed subject matter include low molecular weight pre-polymers or higher molecular weight oligomers and polymers. The epoxy resin comprises at least two epoxide groups per molecule, and can be a polyfunctional epoxide having three, four, or more epoxide groups per molecule. In some embodiments, the epoxy resin is liquid at ambient temperature. Suitable epoxy resins include the mono- or poly-glycidyl derivative of one or more of the group of compounds comprising aromatic diamines, aromatic monoprimary amines, aminophenols, polyhydric phenols, polyhydric alcohols, polycarboxylic acids and the like, or a mixture thereof. In some embodiments, the epoxy resin is selected from the group comprising: (i) glycidyl ethers of bisphenol A, bisphenol F, dihydroxydiphenyl sulphone, dihydroxybenzophenone, and dihydroxy diphenyl; (ii) epoxy resins based on Novolacs; and (iii) glycidyl functional reaction products of m- or p-aminophenol, m- or p-phenylene diamine, 2,4-, 2,6- or 3,4-toluoylene diamine, 3,3′- or 4,4′-diaminodiphenyl methane. In some embodiments, the epoxy resin is selected from the diglycidyl ether of bisphenol A (DGEBA); the diglycidyl ether of bisphenol F (DGEBF); O,N,N-triglycidyl-para-aminophenol (TGPAP); O,N,N-triglycidyl-meta-aminophenol (TGMAP); and N,N,N′,N′-tetraglycidyldiaminodiphenyl methane (TGDDM).

The thermoset resin of the presently disclosed subject matter can be thermally curable. The addition of curing agent(s) and/or catalyst(s) to the resin mixture is optional; the use of such can increase the cure rate and/or reduce the cure temperatures, if desired. In some embodiments, one or more curing agent(s) are used, optionally with one or more catalyst(s). In some embodiments, the thermoset resin is thermally cured without the use of curing agents or catalysts.

If used, curing agents suitable for use with epoxy resins, include, but are not limited to, amines (e.g., polyamines and aromatic polyamines), imidazoles, acids, acid anhydrides, phenols, alcohols, and thiols (e.g., polymercaptans). In some embodiments, the curing agent is a polyamine compound selected from the group comprising diethylenetriamine (DETA), triethylenetetramine (TETA), tetraethylenepentamine (TEPA), ethyleneamine, aminoethylpiperazine (AEP), dicyanamide (Dicy), diethyltoluenediamine (DETDA), dipropenediamine (DPDA), diethyleneaminopropylamine (DEAPA), hexamethylenediamine, N-amino-ethylpiperazine (N-AEP), menthane diamine (MDA), isophoronediamine (IPDA), m-xylenediamine (m-XDA) and metaphenylene diamine (MPDA). In some embodiments, the amine curing agent is selected from the group including 3,3′- and 4-,4′-diaminodiphenylsulphone (DDS); methylenedianiline; bis(4-amino-3,5-dimethylphenyl)-1,4-diisopropylbenzene; bis(4-aminophenyl)-1,4-diiso-propyl-benzene; 4,4′methylenebis-(2,6-diethyl)-aniline (MDEA); 4,4′-methylene-bis-(3-chloro, 2,6-diethyl)-aniline (MCDEA); 4,4′methylenebis-(2,6-diisopropyl)-aniline (M-DIPA); 4,4′methylenebis-(2-isopropyl-6-methyl)-aniline (M-MIPA); 4 chlorophenyl-N,N-dimethyl-urea; 3,4-dichlorophenyl-N,N-dimethyl-urea, and dicyanodiamide. Bisphenol chain extenders, such as bisphenol-S or thiodiphenol, can also be useful as curing agents for epoxy resins. Suitable curing agents further include anhydrides, particularly polycarboxylic anhydrides, such as nadic anhydride, methylnadic anhydride, phthalic anhydride, tetrahydrophthalic anhydride, hexahydrophthalic anhydride, methyltetrahydrophthalic anhydride, endomethylenetetrahydrophtalic anhydride, or trimellitic anhydride.

In some embodiments, the thermoset resin can include one or more catalyst(s) to accelerate the curing reaction. Suitable catalysts are well known in the art and include Lewis acids or bases. Specific examples include compositions comprising boron trifluoride, such as the etherates or amine adducts thereof (for instance the adduct of boron trifluoride and ethylamine).

The most common resins for aerospace applications are thermoset resins, such as esters and epoxies. Some of the most common epoxies used are tetraglycidyl methylene dianiline (TGMDA) and diglycidyl ether of biphenol A (DGEBA). Thermoset resins polymerize to a permanently solid and infusible state upon the application of heat. Once the thermoset resin has hardened, it cannot be reliquidified without damaging the material. Thermoset resins have excellent adhesion, high thermal stability, high chemical resistance and less creep than thermoplastics. Since their viscosity is low, the fabric can be completely wetted prior to the end of the gel time.

Vinyl ester resins have a higher failure strain than polyester resins. This characteristic improves the mechanical properties, the impact resistance, and the fatigue performance. In some examples, the formulation process for vinyl esters comprises weighing out and mixing a promoter, a catalyst, and a retarder by specific percentages to the resin weight. The promoter expedites the curing process. The catalyst promotes or controls the curing rate of the resin and the retarder absorbs any free radicals remaining once the exothermic reaction begins.

As stated previously, the thermoset resin cures when heat is applied. In some examples, the heat is generated by the interaction of the resin with the catalyst. The other two components control the rate of cure. Most vinyl esters cure at ambient room temperature. Thermoplastic resins flow when subjected to heat and pressure, and then solidify on cooling without undergoing cross-linking. Thermoplastic resins can be reliquidified since the material does not cross-link.

Polymerization is the chemical reaction in which one or more small molecules combine to form a more complex chemical, with a higher molecular weight. Typical examples are polyethylene, nylon, rayon, acrylics and PVC (polyvinyl chloride). Cross-linking is the joining or intermingling of the ends of the chemical bonds that make the material stronger and harder to pull apart, thus providing good mechanical properties.

Vinyl ester resins (or esters generally) can be chemically similar to both unsaturated polyesters and epoxy resins. They were developed as a compromise between the two materials, providing the simplicity and low cost of polyesters and the thermal and mechanical properties of epoxies. Vinyl esters can also be used in wet lay-ups and liquid molding processes such as RTM. Unsaturated polyester resins are Alkyd thermosetting resins characterized by vinyl unsaturation in the polyester backbone. The definition of unsaturation is any chemical compound with more than one bond between adjacent atoms, usually carbon, and thus reactive toward the addition of other atoms at that point. Alkyd resins are polyesters derived from a suitable dibasic acid and a polyfunctional alcohol. A dibasic acid is an acid that contains two hydrogen atoms capable of replacement by basic atoms or radicals. A radical is either an atom or molecule with at least one unpaired electron, or a group of atoms, charged or uncharged, that act as a single entity in the reaction. Carboxyl groups also react with amine groups to form peptide bonds and with alcohols to form esters. Condensation polymerization occurs when monomers bond together through condensation reactions. Typically, these reactions are achieved through reacting molecules that incorporate alcohol, amine or carboxylic acid (also known as organic acid) functional groups. These unsaturated polyesters are most widely used in reinforced plastics.

Epoxy resins are a family of thermosetting resins generally formed from low molecular weight diglycidyl ethers of bisphenol A. Depending on the molecular weight, the resins range from liquids to solids and can be cured with amines, polyamides, anhydrides or other catalysts. Epoxy resins are also widely used in reinforced plastics because they have good adhesion to fibers. In addition, their low viscosities are effective in wetting various reinforcing materials. In the aerospace market, the most widely used resins are epoxy resins. They have a high curing temperature of around 350° F. (177° C.), which places their Tg at 302° F. (150° C.). Tg is the glass transition temperature. No other resin on the market can contend with this high Tg. Epoxies have high fracture toughness, which make their fatigue performance superior to vinyl esters. They also have a low cure shrinkage rate compared to vinyl esters, so there is less possibility of cracking or crazing during the cure of components. The formulation of epoxies is also simple; it comprises two parts, the epoxy and the curing agent. The ratio of these two components provides the rate at which the mixture cures. The epoxy determines the mechanical properties and the curing agent determines the cure temperature. Some of the most common epoxies used are TGMDA (tetraglycidyl methylene dianiline) and DGEBA (diglycidyl ether of biphenol A). The TGMDA epoxy has higher mechanical properties and higher Tg than the DGEBA epoxy. The DGEBA epoxy has a higher failure strain and lower water absorption than the TGMDA epoxy.

Additional examples of suitable resins include those having suitable characteristics to DM 411-350 vinyl ester manufactured by the Dow Chemical Company, Inc. and EPON™ Resin Systems manufactured by Hexion Inc. (Columbus, Ohio, United States of America)., such as EPON® 9504, EPON® 862 and EPON® 826. Both resins types have high Tg's. DM411-350 is used in adverse chemical environments, and its applications include chemical processing, pulpwood and paper processing. It is used in the food and beverage industry, but it is not currently being used in aerospace applications. EPON™ resins have high tensile strength and elongation properties, which can be important in composite applications. EPON™ resins are a two-part system. The second part is EPI-Cure® Curing Agent. The EPON™ resins have viscosities that work well between the 100 to 350° F. range and are easy to mix and work with in the manufacture of composites.

### VI. FIBERS/FABRICS

The selection of fibers for the composites disclosed herein is guided by the end use of the composite (e.g., the structural composite) and can be influenced by a range of factors, such as mechanical properties, cost and manufacturability. Accordingly, the properties desired in the final composite should be considered.

Typically, fibers employed in the methods of the presently disclosed subject matter comprise carbon fibers, glass fibers, metallic fibers, or ceramic fibers. The fibers can be woven or non-woven. In some embodiments, the one or more layers of woven fibers comprise plain weave, twill weave, satin weave, 4 harness satin weave, 5 harness satin weave, or 8 harness weave. Non-woven fibers can be uni-directional, providing high strength benefit, while woven fibers can improve workability. The choice between woven and non-woven and the type of weave is based on the targeted use for the manufactured composite.

Carbon fibers are well-known to those of skill in the art and include components of carbon fiber reinforced polymers, generally prepared from polyacrylonitrile, rayon or petroleum pitch.

A variety of glass fibers are known to those of skill in the art, including but not limited to, electric grade fiberglass (E-glass; low alkali borosilicate glass), structural grade fiberglass (S-glass; a high strength magnesia-alumina-silicate) and resistance grade fiberglass (R-glass; a high strength alumino silicate glass that does not contain magnesium oxide or calcium oxide).

The fibers can also be made from high-strength materials such as ceramics, including but not limited to, alumina, alumina-silica, zirconia, mullite, silicon carbide, as well as quartz. A representative, non-limiting example of a material for a metallic fiber is steel.

### VII. EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Materials and Methods

Plain weave carbon fabric (Fiber Glast Development Corp., Brookville, Ohio, United States of America) was used as the reinforcement material. The epoxy resin was phenol formaldehyde polymer glycidyl ether (commercially available under the trade name EPON™862 (Hexion, Inc., Columbus, Ohio, United States of America), and the curing agent was diethylmethylbenzediamnine, commercially available under the tradename EPIKURE™ W (Hexion, Inc., Columbus, Ohio, United States of America).

### Fabrication

The viscosity of epoxy resin at room temperature is typically 2.2-4.2 Pa-s, which produces low-quality panels. In the present study to avoid this low viscosity problem, composite laminates were fabricated using HVARTM (Heated vacuum assisted resin transfer molding) process, shown schematically in FIG. 1, and as disclosed in U.S. Pat. No. 9,114,576, herein incorporated by reference in its entirety. Generally, the temperature of the entire system (mold, fabric, and plastic bag) was increased to 120° F. to achieve a good flow of resin. At this temperature, the resin sold under the tradename EPON™862 (Hexion Inc., Columbus, Ohio, United States of America) has a viscosity of 0.1-0.15 Pa-s. One thermocouple was located at the top of the insulating material, and one at the bottom of the glass, minimizing the gradient between the bottom of the glass to the outermost bag on the top. This even heating allows uniform coating and distribution of the resin. A 609.6 mm×609.6 mm (24″×24″) silicone rubber laminated heating pad (Omega) was used. A glass mold of 609.6 mm×609.6 mm (24″×24″) piece of 12.7 mm (0.5″) thick was used for the fabrication. The sealant tape was applied to create the composite vacuum bag making sure to leave the paper backing on the top side. The bag was approximately 177 mm (7″) taller and 50 mm (2″) wider than the laminate itself. A mold release agent sold under the tradename FREKOTE™ 770-NC (Henkel IP & Holding GMBH, Duesseldorf, Germany) mold release was wiped on the mold with a paper towel and allowed to dry. The mold release prevents any epoxy that contacts the tool from sticking making it easier to remove after fabrication is complete. After applying release agent on mold, the plastic film was placed on the mold to protect the surface. The plastic is another way to protect the mold surface from the epoxy, which will only be exposed around the edge between the plastic and sealant tape. Resin distribution medium was a nylon mesh, which acts as a spacer between the plastic and the peel ply layer on both the top and bottom, which enables the resin to flow allowing it to distribute evenly. Bottom and top release fabric laid between distribution medium and fabric. The size of the composite panel was 355.6 mm×406.4 mm (14″×16″). There were 12 layers or plies of plain weave stacked one above the other. Before the bag was created, inlet and outlet ports were added to infuse resin and to create a vacuum. Resin and vacuum distribution line included silicone spiral cut tube; the length of the spiral cut tubing required was approximately equal to the width of the top side of the vacuum bag. These lines were laid above the distribution media at two sides of the fabric lay-up and go along the length. The resin line was closed at one end and connected to resin supply another end. Sealant tape was wrapped around the silicone tube within an inch of the end in which the spiral cut tube was inserted, making sure to overlap and seal the tape on itself to create a seal.

The composite laminates were fabricated using 12 layers of plain weave carbon fabric with areal weight 190 gsm using T700SC carbon fiber toes. After curing, the expected thickness of the panel was 2.6 mm (0.1″). To make pin inserted holes in the panel, metal pins were cut from a rod of 6.35 mm (0.25″) diameter. Five metal pins of length 2.7 mm (0.106 mm) were cut from a rod and polished on both sides to remove the burr. The release agent (sold under the tradename FREKOTE™ 770-NC, Henkel IP & Holding GMBH, Duesseldorf, Germany) was applied to the pins so that after curing, they could easily be removed from the laminate without damaging the fiber strands. The coated pins were then inserted in dry fibers stacked together (FIG. 2).

According to manufacturer instructions, EPON™862 and the curing agent W were mixed at the weight ratio of 100:26.4 and stirred for about 4 minutes. It was then degasified and heated for 30 minutes at 176° F. and infused into the dry stacked fibers using the HVARTM method. The sample was then cured (per the cycle shown in FIG. 3). The HVARTM resin infused panel with inserted pin was cut into open hole compression coupons per ASTM D6484 (as generally disclosed in ASTM Standard D6484-14, 2014 “Standard Test Method for Open-Hole Compressive Strength of Polymer Matrix Composite Laminates” ASTM International, West Conshohocken, Pa., DOI: 10.1520/D6484_D6484M-14) standards using a water jet machine to obtain holes precisely at the center of the coupon. Another five coupons were waterjet cut such that a hole was drilled at the center. Another five coupons were waterjet cut without a hole; the center point was marked on these five coupons and a twist drill of 6.35 mm (0.25″) diameter was used to make a center hole (FIG. 4).

### Characterization

Open hole compression tests, used to determine the strength of multidirectional polymer matrix composite laminates reinforced by high-modulus fibers, were performed according to ASTM D6484 standard, using Instron electromechanical testing system at the strain rate of 1.27 mm/min, consistent with the method disclosed in Kelkar, A. D., Tate, J. S., and Chaphalkar, P., 2006, “Performance Evaluation of VARTM Manufactured Textile Composites for the Aerospace and Defense Applications,” Mater. Sci. Eng. B Solid-State Mater. Adv. Technol., 132(1-2), pp. 126-128.

Five test specimens were tested per the ASTM D6484 standard for each panel of coupons as described above and compressive strength and failure modes were recorded. Stress vs extension curve data were plotted, and compressive strength and strain energy was calculated. It is related to the area under the load extension curve such as that developed when a compression test is performed because energy absorption is the summation of all the force resistance effects within the system. Strain energy is calculated by using trapezoidal rule over the load-extension curve.

Cracks propagated from the hole side of the specimens, leading to failure for each of the drilled hole (FIG. 5A) and the waterjet cut hole (FIG. 5B) specimens. One of the specimens prepared having a pin inserted hole in accordance with the presently disclosed subject matter did show a crack that propagated on the downward portion of the hole, but there was no failure observed at the center of the hole, due to the continuity of the fibers in the specimen (FIG. 5C). Microscopic imaging showed drilled hole fibers after failure in a drilled hole sample. Some fiber pulls out and cut fibers were present on the inside surface of the hole in a waterjet cut hole. Edge fiber remained aligned in a pin inserted hole in accordance with the presently disclosed subject matter after coupon failure, with some broken fibers observed around the edge of a hole in the pin inserted coupon failure. SEM images of drilled hole fibers showed cut fibers on the circular face of the specimen; delamination of a drilled hole specimen; fiber separation inside the hole of the waterjet cut hole; and the inside part of pin inserted hole in accordance with the presently disclosed subject matter showed no burr or delamination.

### Results

The compressive strength of the specimen with a pin inserted hole (of the presently disclosed subject matter) was 300±41.05 MPa, a 38% increase over the compressive strength of the drilled and waterjet cut holes (216±8.07 and 219±27.39 MPa respectively), albeit with more variation. With respect to the Failure Mode all specimens failed LGM: failure type is lateral (L), failure area is gauge (G) and location is middle (M) except for specimen 4, a pin inserted hole prepared in accordance with the presently disclosed subject matter, which had a Failure Mode of LGB: failure type is lateral (L), failure area is gauge (G) and location is bottom (B) (FIG. 5C).

TABLE 1
Compressive strength (MPa) of hole fabricated by drilling,
waterjet cutting, and pin insertion in the dry laminate
(method of the presently disclosed subject matter)

| | Compressive strength (MPa) | | |
|---|---|---|---|
| Coupon # | Drilled | Waterjet Cut | Pin inserted |
| 1 | 204.07 | 228.92 | 275.81 |
| 2 | 214.87 | 187.69 | 320.23 |
| 3 | 220.17 | 200.12 | 338.39 |
| 4 | 225.92 | 220.43 | 240.81 |
| 5 | 214.85 | 258.55 | 327.77 |
| Average | 215.98 | 219.14 | 300.60 |
| SD | 8.07 | 27.39 | 41.05 |

Table 2 shows the compressive strain of laminates for the hole made by three different methods. The Percentage Compressive strain of pin inserted holes of the presently disclosed subject matter was much higher than holes fabricated by using drilling or waterjet cut fabrication methods.

TABLE 2
Compressive strain (%) of holes made by drilling,
waterjet cut, and pin inserted method (method
of the presently disclosed subject matter)

| | Compressive strain (%) | | |
|---|---|---|---|
| Coupon # | Drilled | Waterjet Cut | Pin inserted |
| 1 | 0.41 | 0.57 | 0.60 |
| 2 | 0.41 | 0.48 | 0.70 |
| 3 | 0.48 | 0.51 | 0.77 |
| 4 | 0.49 | 0.69 | 0.69 |
| 5 | 0.50 | 0.62 | 0.80 |
| Average | 0.46 | 0.57 | 0.71 |
| SD | 0.04 | 0.08 | 0.07 |

The strain energy (area under the load-extension curve, FIG. 6) was plotted for all three cases. There was significant improvement in the strain energy absorbed in the coupons where hole was fabricated by inserting the pin according to the methods disclosed herein, as compared to holes made by either drilling or waterjet methods. This is consistent with the observation that the holes formed by the method of the presently disclosed subject matter showed little or no damage to the fiber strands in the laminates.

To study the fatigue life of carbon fiber laminates with the holes made by each of the methods (inserting pin, conventional drilling and non-conventional waterjet technique), coupons were fabricated as disclosed above, and tensile strengths were obtained using tensile tests per ASTM 3039 standards (Table 3).

TABLE 3
Tensile Strength (N/mm²) of coupons containing
holes made by drilling, waterjet cut, and pin
inserted method (the presently disclosed method)

| Pin Inserted | Waterjet cut | Conventional Drilling |
|---|---|---|
| 455.82 ± 23.62 | 355.80 ± 16.36 | 382.75 ± 29.13 |

Fatigue tests were conducted per ASTM D3479 standards at two different loading conditions. The first loading condition was application of 80% the ultimate tensile strength of the pin inserted samples as reported in Table 3 (see Table 4 and FIG. 7A-7C). The second loading condition was application of 60% the ultimate tensile strength of water jet cut holes samples as reported in Table 3 (see Table 5 and FIG. 8A-8C). An R ratio (the ratio of the minimum peak to the maximum peak stress) of 0.1 and the frequency of 3 Hz was used in the study.

TABLE 4
Number of cycles at failure for 80% of
loading of pin inserted holes specimen.

| Pin inserted hole | Drilled hole | Waterjet cut hole |
|---|---|---|
| 1754 | 39 | 2 |
| 3570 | 11 | 2 |
| 11872 | | 6 |

TABLE 5
Number of cycles at failure for 60% of loading
of water jet cut holes specimen.

| Pin inserted hole | Drilled hole | Waterjet cut hole |
|---|---|---|
| | 100,729 (did not fail) | 245 |
| 132,452 | 100,169 (did not fail) | 35 |
| 100,222 (did not fail) | | |

The fatigue study clearly indicated that coupons manufactured using the pin inserted method demonstrated superior performance at the tensile loading in addition to having significantly better performance under the tension-tension fatigue loading compared to the performance of the coupons fabricated using drilling and waterjet methods. Without being bound by theory, the improved performance of the pin inserted holes can be attributed to the presence of continuous fibers, which arrest crack propagation and surround the hole during fatigue loading, thereby delaying crack growth.

The patents and publications listed herein describe the general skill in the art. All publications, patents, and patent applications mentioned in this specification are herein incorporated by reference to the same extent as if each individual publication, patent, or patent application was specifically and individually indicated to be incorporated by reference. In the case of any conflict between a cited reference and this specification, the specification shall control.

In describing embodiments of the present subject matter, specific terminology is employed for the sake of clarity. However, the presently disclosed subject matter is not intended to be limited to the specific terminology so selected. Nothing in this specification should be considered as limiting the scope of the presently disclosed subject matter. All examples presented are representative and non-limiting. The above-described embodiments can be modified or varied, without departing from the presently disclosed subject matter, as appreciated by those skilled in the art in light of the above teachings. It is therefore to be understood that, within the scope of the claims and their equivalents, the presently disclosed subject matter can be practiced otherwise than as specifically described.

What is claimed is:

1. A method of preparing a composite comprising a polymeric matrix and one or more sheets of fibers, the method comprising:
(a) providing one or more layer of fibers;
(b) inserting one or more pins in the one or more layers of fibers;
(c) contacting the one of more layers of fibers with a resin for forming the polymeric matrix;
(d) curing the resin to form the polymeric matrix; and
(e) removing the one or more pins, thereby preparing a composite wherein the composite comprises one or more holes extending from an outer surface of the composite toward or all the way to an opposite outer surface of the composite.

2. The method of claim 1, wherein the one or more layers of fibers comprise carbon fibers, glass fibers, metallic fibers or ceramic fibers.

3. The method of claim 2, wherein the one or more layers of carbon fibers or glass fibers comprise plain weave, twill, satin, or 8 harness weave.

4. The method of claim 1, wherein the one or more layers of fibers comprises at least about 4 layers.

5. The method of claim 1, wherein step (c) comprises contacting the one or more layers of fiber with a resin for forming a thermoset polymeric matrix and a curing agent.

6. The method of claim 5, wherein the resin for forming a thermoset polymeric matrix is an epoxy resin.

7. The method of claim 1, wherein the curing of step (d) is performed using heat.

8. The method of claim 1, wherein the contacting of step (c) and the curing of step (d) are performed using a mold.

9. The method of claim 1, wherein the contacting and curing steps are performed as part of a vacuum assisted resin transfer molding (VARTM) or heated vacuum assisted resin transfer molding (HVARTM) process.

10. The method of claim 1, wherein one or more of a compressive strength, a tensile strength, or a fatigue life of the composite is greater than a compressive strength, a tensile strength, or a fatigue life of a composite comprising drilled or waterjet cut holes and/or where the composite is free of cracks propagating from a side of a hole into the polymeric matrix.

11. The method of claim 10, wherein the compressive strength of the composite is at least about 38% more than the compressive strength of a composite comprising drilled or water jet cut holes.

12. The method of claim 10, wherein the tensile strength of the composite is at least about 28% more than the tensile strength of a composite comprising drilled or water jet cut holes.

13. The method of claim 10, wherein the fatigue life of the composite is at least about 400% more than the fatigue life of a composite comprising drilled or water jet cut holes.

14. The method of claim 1, wherein the composite can sustain more compressive or tensile stress than a composite comprising drilled or waterjet cut holes.

15. The method of claim 1, further comprising joining the composite to another structure via mechanical fastening using the holes.

16. The method of claim 1, wherein the composite is used as a part for a vehicle, a building, a civil infrastructure installation or a piece of sporting equipment.

17. A composite prepared by the method of claim 1.

18. A composite material comprising:
(a) a polymeric matrix; and
(b) one or more layers of fiber surrounded by the polymeric matrix;
wherein the composite material comprises one or more holes extending from one outer surface of the composite material toward or through an opposite outer surface of the composite material, wherein said one or more holes extend through at least one of the one or more layers of fiber; and wherein the one or more layers of fiber are free of broken and/or pulled fibers at or near the vicinity of the one or more holes and/or wherein the composite material is free of delamination and/or cracks emanating from the one or more holes.

19. The composite material of claim 18, wherein the polymeric matrix is a thermoset polymeric matrix.

20. The composite material of claim 19, wherein the thermoset polymeric matrix is an epoxy matrix.

21. The composite material of claim 18, wherein the one of more layers of fiber comprise carbon fiber.

22. The composite material of claim 18, wherein said composite material is a part for an airplane, a spaceship, a car, a truck, a boat, a building, a civil infrastructure installation or a piece of sporting equipment.
